(19) United States
(12) Patent Application Publication
(10) Pub. No.: US 2019/0353941 A1
(43) Pub. Date: Nov. 21, 2019

(54) PROCESSING PROCESS AND DEVICE FOR DISPLAY PANEL

(71) Applicants: HKC CORPORATION LIMITED, Guangdong (CN); CHONGQING HKC OPTOELECTRONICS TECHNOLOGY CO., LTD., Chongqing (CN)

(72) Inventor: CHUNG-KUANG CHIEN, Chongqing (CN)

(73) Assignees: HKC CORPORATION LIMITED, Guangdong (CN); CHONGQING HKC OPTOELECTRONICS TECHNOLOGY CO., LTD., Chongqing (CN)

(21) Appl. No.: 16/318,536

(22) PCT Filed: Aug. 31, 2017
(86) PCT No.: PCT/CN2017/100029

§ 371 Date: Jan. 17, 2019

(30) Foreign Application Priority Data
Dec. 30, 2016 (CN) 201611269796.6

(51) Int. Cl. G02F 1/13; G02F 1/1333; G02F 1/1339; C03B 33/02

(52) U.S. Cl. CPC G02F 1/1303; G02F 1/133308; G02F 1/13458; C03B 33/02; G02F 2001/133331; G02F 1/1339

(57) ABSTRACT

A processing process and processing device for a display panel are provided. The processing process for a display panel includes: an insulating spacer layer is arranged between a cutting region of a glass panel to be cut of a liquid crystal board and an array pad; a single-sided glass panel of the liquid crystal board is subjected to single glass cutting process; residual material is taken out from split pieces on a split region of the cut glass panel of the liquid crystal board; and the spacer layer is removed, the array pad is exposed, and then the liquid crystal board is outputted.

### TECHNICAL FIELD

The present disclosure relates to a processing process and a processing device for a display panel.

### BACKGROUND

In related art, an array pad (a matrix metal layer) is exposed after a semi-finished product of a liquid crystal panel is subjected to single glass cutting by working personnel. After the glass is cut, residual material needs to be taken out of split pieces and a voltage is applied to a UVM Pad (a voltage driven metal layer for ultraviolet curing) in a sub subsequent procedure, thereby completing a polymerization reaction process of liquid crystal molecules. However, in a current technology, since upper and lower substrates in the liquid crystal panel are in large-area contact and lots of static electricity may be generated during cutting, the lower substrate cannot be separated due to the static electricity when the residual material is taken out, affecting a subsequent procedure in which a voltage is applied to the UVM Pad, thereby affecting a processing yield of the liquid crystal panel and reducing production efficiency of liquid crystal panel products.

### SUMMARY

According to one aspect of the present disclosure, a processing process for a display panel is provided, and the processing process includes the following steps:

arranging an insulating spacer layer between a cutting region of a glass panel to be cut and an array pad;

performing single glass cutting on the single-sided glass panel of a liquid crystal board;

taking out residual material from split pieces in a split region of the glass panel of the liquid crystal board after the glass panel is cut; and

removing the spacer layer, exposing the array pad, and then outputting the liquid crystal board.

According to another aspect of the present disclosure, a processing device for a display panel is provided. The processing device for a display panel includes: a transmission apparatus configured to transmit a liquid crystal board; a clamping apparatus configured to clamp the liquid crystal board and arranged at an output port of the transmission apparatus; a cutting apparatus installed correspondingly to the clamping apparatus and configured to perform single glass cutting on the liquid crystal board; a removal apparatus installed at a downstream of the clamping apparatus, butted with the clamping apparatus and configured to, after the single cutting is completed, take out residual material from split pieces formed by cutting the liquid crystal board; and an output apparatus arranged at a downstream of the removal apparatus and butted with the removal apparatus.

The present disclosure further provides a processing process for a display panel, including:

arranging a spacer layer between a cutting region of a glass panel to be cut and an array pad, the spacer layer preventing static electricity between the glass panel and the array pad;

performing single glass cutting on the cutting region of the glass panel;

taking out residual material from split pieces on the glass panel after the glass panel is cut; and

removing the spacer layer, exposing the array pad, and then outputting the liquid crystal board.

### BRIEF DESCRIPTION OF DRAWINGS

FIG. 1 is a structural schematic diagram illustrating a display panel at different phases of a processing process for a display panel in a related art;

FIG. 2 is a structural schematic diagram illustrating a device in embodiments of a processing process for a display panel in the present disclosure; and

FIG. 3 is a flowchart block diagram illustrating embodiments of a processing process for a display panel in the present disclosure.

In the figures:

| | |
|---|---|
| 10. liquid crystal board; | 11. glass panel; |
| 12. array pad; | 20. spacer layer; |
| 30. clamping apparatus; and | 40. cutting tool. |

### DETAILED DESCRIPTION

It should be noted that, when an element is referred to as “fixed to” or “arranged at” another element, the element can be directly or indirectly arranged on the another element. When one element is referred to as “connected to” another element, the element can be directly or indirectly connected to the another element.

It should also be noted that, orientation terms such as left, right, upper, lower and the like in the present embodiment are only mutually opposite concepts or take a normal usage state of a product as reference, while should not be considered to have a limitation.

Explanation:

(1) SCU, that is, Single Glass Cut, a single glass cutting process.

(2) UVM Pad, that is, a voltage driven metal layer for ultraviolet curing, namely an operation of applying a voltage to the voltage driven metal layer for ultraviolet curing in a subsequent procedure after the single glass cutting process is performed on the liquid crystal board.

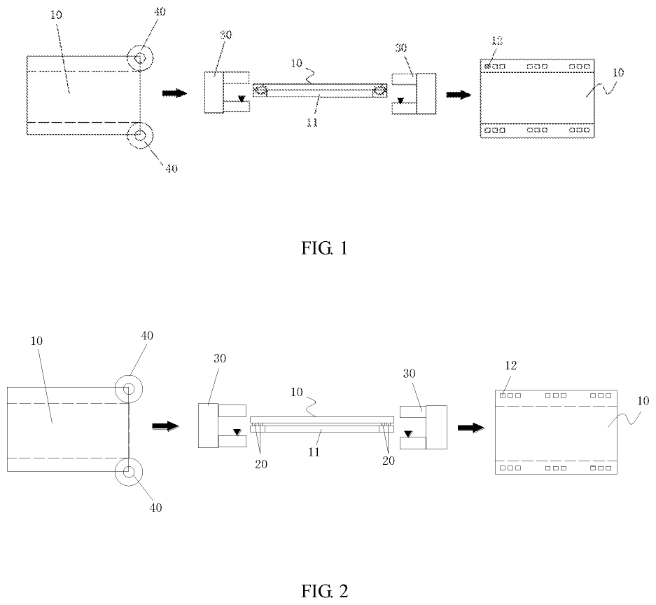

As shown in FIG. 1, in a relevant art, a cutting region of a glass panel 11 in a liquid crystal board 10 and an array pad 12 are directly contacted or are connected through an adhesive layer. Static electricity is generated due to friction between a cutting tool 40 and the glass panel 11 in the cutting process. Since the static electricity has static electricity absorption capability on adhesive glue or tiny glass split pieces, the glass split pieces cannot be separated from the array pad 12 or cannot be completely separated after the cutting is completed, so that the operation of applying the voltage to the UVM Pad in the subsequent procedure cannot be performed and a normal processing procedure must be stopped to perform related inspection or a production yield of the liquid crystal panel is directly reduced, thereby reducing production efficiency of the liquid crystal board 10.

In order to solve the above technical problem, the inventor proposes the following solution through in-depth study.

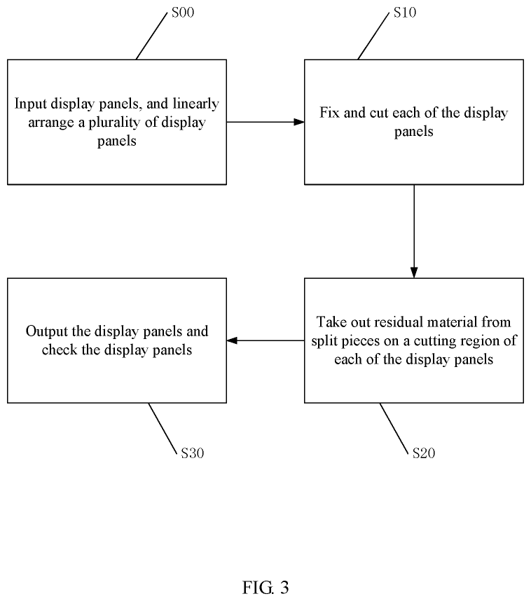

As shown in FIG. 2 and FIG. 3, the solution provided by the present disclosure is the processing process for a display panel. The technical solution includes steps S10-S30 as follows:

At Step S10: a single-sided glass panel 11 of the liquid crystal board 10 is subjected to single glass cutting process.

At Step S20: residual material is taken out from split pieces on a split region of the glass panel 11 of the liquid crystal board 10 after cutting, with an insulating spacer layer 20 being additionally arranged between the split region of the cut glass panel 11 and the array pad 12. The spacer layer 20 prevents static electricity from being generated between the glass panel 11 and the array pad 12.

At Step S30: the spacer layer 20 is removed, the array pad 12 is exposed, and then the liquid crystal board 10 is outputted.

In the processing process for a display panel, the insulating spacer layer 20 is additionally arranged between the split region of the cut glass panel 11 and the array pad 12, and the spacer layer 20 has a function of preventing the static electricity from being generated between the glass panel 11 and the array pad 12, thereby eliminating the static electricity generated between the glass panel 11 and the array pad 12 in the cutting process, so that the split region of the glass panel 11 can be smoothly separated from the array pad 12, thereby ensuring a normal operation of applying the voltage to the UVM Pad in the subsequent procedure, increasing the production yield of the liquid crystal board 10 and ensuring production and processing efficiency of the liquid crystal board 10.

In a process of additionally installing, between the split region of the cut glass panel 11 and the array pad 12, the insulating spacer layer 20 for preventing the static electricity from being generated between the glass panel 11 and the array pad 12, the array pad 12 in the targeted liquid crystal board 10 in the processing process for a display panel may be arranged in multiple manners. Optionally, the spacer layer 20 is laid and brushed on the array pad 12, and then the glass panel 11 is arranged on the spacer layer 20. The laying and brushing arrangement manner can ensure that the spacer layers 20 are uniformly distributed, thereby ensuring thickness uniformity of the liquid crystal board 10. A defect condition of thickness nonuniformity may occur on the liquid crystal board 10 after a surface treatment, and thus production quality of the liquid crystal board 10 needs to be ensured. Certainly, other arrangement manners capable of ensuring uniform distribution of the spacer layers 20 in all positions can also be adopted by the spacer layers 20.

Optionally, the spacer layer 20 is made of polyimide or polymethyl methacrylate material. The material not only has an effective function for preventing the static electricity from being generated between the glass panel 11 and the array pad 12, but also has no adhesion property with the glass panel 11 and the array pad 12 and can be easily dropped and separated, so that a separation effect can be quickly achieved in the split region after cutting and splitting.

In order to ensure cutting stability, the liquid crystal board 10 is fixedly clamped by a clamping apparatus 30 in the processing procedure of the step S10, and two opposite side edges of the liquid crystal board 10 are symmetrically clamped by the clamping apparatus 30. Optionally, the clamping apparatus 30 can further serve as a positioning device of the cutting tool 40 in the cutting process, so that the accuracy of a cutting route of the cutting tool 40 may be ensured in the cutting process. In addition, a cutting depth is controlled by controlling a feed amount of the cutting tool 40 along a direction perpendicular to a board surface of the liquid crystal board 10.

As shown in FIG. 3, in the process of completing the step S30, after the spacer layer 20 is removed and the array pad 12 is exposed, the split region of the liquid crystal board 10 is checked by a line scan camera to judge whether the split region meets a cutting requirement, and then the liquid crystal board 10 is outputted. A split piece separating effect is analyzed through a computer of a checking system with respect to image data obtained by the line scan camera, thereby rapidly judging completion quality of the SCU process. The liquid crystal board 10 is subjected to scrap disposal when a judgment result of the completion quality of the SCU process does not meet the requirement; and the liquid crystal board 10 is outputted when the judgment result of the completion quality of the SCU process meets the requirement, thereby performing a process for applying the voltage to the UVM Pad in the subsequent procedure.

In the processing process for a display panel of the present disclosure, a plurality of liquid crystal boards are arranged in sequence before the step S10, so as to perform continuous SCU process, thereby forming a large-scale assembly line type production manner and increasing production efficiency of the liquid crystal boards.

According to another aspect of the present disclosure, a processing device for a display panel is provided. The processing device for a display panel includes a transmission apparatus configured to transmit a liquid crystal board 10, a clamping apparatus 30 configured to clamp the liquid crystal board 10, a cutting apparatus, a removal apparatus and an output apparatus. The clamping apparatus 30 is arranged at an output port of the transmission apparatus. The cutting apparatus is arranged correspondingly to the clamping apparatus 30 and is configured to perform single glass cutting on the liquid crystal board 10. The removal apparatus is installed at a downstream of the clamping apparatus 30, butted with the clamping apparatus 30 and performs an operation of taking the residual material from split pieces formed by cutting the cut liquid crystal board 10. The output apparatus is arranged at a downstream of the removal apparatus and butted with the removal apparatus.

As shown in FIG. 2, in the process of processing a display panel, the liquid crystal board 10 is transmitted into the clamping apparatus 30 through the transmission apparatus to be clamped and mounted, and then the liquid crystal board 10 is subjected to single glass cutting process through the cutting tool 40 of the cutting apparatus after fixedly clamped on the clamping apparatus 30. After the single glass cutting process of the liquid crystal board 10 is completed, cut split pieces formed on the liquid crystal board 10 after the cutting is completed are taken out by utilizing the removal apparatus. The residual material of the glass panel needing to be removed in the single glass cut process is removed to expose the array pad 12. Finally, the processed liquid crystal board 10 is transmitted to a subsequent processing device through the output apparatus so as to perform a subsequent procedure of applying the voltage to the UVM Pad on the array pad 12.

In order to ensure that each liquid crystal board 10 in the subsequent procedure of applying the voltage to the UVM Pad is a qualified to-be-processed board, the processing device for a display panel further includes a detection apparatus configured to detect the quality of the cutting process of the liquid crystal board 10. The detection apparatus is installed correspondingly to the removal apparatus and is arranged oppositely to a cutting region of the liquid crystal board 10. In embodiments of the present disclosure, the detection apparatus performs a detection operation by using a line scan camera, and the split region of the liquid crystal board 10 is checked through the line scan camera, thereby judging whether the residual material of the glass panel is completely removed by the removal apparatus and the array pad 12 is exposed, and further judging whether the liquid crystal board 10 subjected to single glass cutting process meets a cutting requirement. If the detection apparatus detects and determines that cutting quality of the liquid crystal board 10 subjected to the single glass process cutting does not meet a processing quality requirement of the subsequent procedure of applying the voltage to the UVM Pad, the liquid crystal board 10 is subjected to scrap disposal; and if the detection apparatus detects and determines that the liquid crystal board 10 meets the processing quality requirement, the liquid crystal board 10 is continuously transmitted into the subsequent processing device by the output apparatus.

As shown in FIG. 3, the processing device for a display panel is composed of the transmission apparatus, the clamping apparatus 30, the cutting apparatus, the removal apparatus, the detection apparatus and the output apparatus. A production and processing station in a display panel processing production line is formed by the production device, and the liquid crystal board is transmitted into the processing station by the transmission apparatus to process the display panel. On an input apparatus, a plurality of liquid crystal boards are arranged one by one to in a linear arrangement, and then transmitted into the clamping apparatus 30 one by one and fixed, and cut by the cutting apparatus. The residual material of the glass panel is removed by the removal apparatus. After checked to be qualified by the detection apparatus, the liquid crystal boards are continuously transmitted to the next processing station by the output apparatus.

As shown in FIG. 2, the clamping apparatus 30 in the processing device for a display panel in embodiments of the present disclosure includes two sets of clamps. The two sets of clamps are arranged oppositely to each other and configured to symmetrically clamp two opposite side edges of the liquid crystal board 10. Moreover, the cutting apparatus also has two sets of cutting tools 40. A cutting path of each set of the cutting tools 40 is respectively parallel to an edge of a corresponding clamp. In the process of clamping the liquid crystal board 10 by utilizing the clamps, in order to avoid direct rigid contact of the clamps with the glass panel of the liquid crystal board 10, an elastic clamping layer contacted with the liquid crystal board is arranged on each set of the clamps. In the process of clamping the liquid crystal board 10, an effect between the clamps and the liquid crystal board 10 is cut down by virtue of the elastic clamping layer, and then the elastic clamping layer generates elastic deformation, thereby protecting the glass panel against fracture due to rigid clamping.

What is claimed is:

1. A processing process for a display panel, comprising:
arranging an insulating spacer layer between a cutting region of a glass panel to be cut of a liquid crystal board and an array pad;
performing single glass cutting on a single-sided glass panel of the liquid crystal board;
taking out residual material from split pieces in a split region of the glass panel of the liquid crystal board after cutting; and
removing the spacer layer, exposing the array pad, and then outputting the liquid crystal board.

2. The processing process for a display panel according to claim 1, wherein the spacer layer is spread and brushed on the array pad, and the glass panel is arranged on the spacer layer.

3. The processing process for a display panel according to claim 2, wherein the spacer layer is made of polyimide.

4. The processing process for a display panel according to claim 2, wherein the spacer layer is made of polymethyl methacrylate.

5. The processing process for a display panel according to claim 1, wherein the liquid crystal board is fixedly clamped by a clamping apparatus when performing single glass cutting on the single-sided glass panel of the liquid crystal board, and two opposite side edges of the liquid crystal board are symmetrically clamped by the clamping apparatus.

6. The processing process for a display panel according to claim 1, wherein after the spacer layer is removed and the array pad is exposed, before the liquid crystal board is outputted, the breaking region of the liquid crystal board is checked by a line scan camera to determine whether the breaking region meets a cutting requirement to output the liquid crystal board.

7. The processing process for a display panel according to claim 1, further comprising
arranging a plurality of liquid crystal boards in sequence so as to perform the machining process for a display panel continuously.

8. The processing process for a display panel according to claim 2, further comprising
arranging a plurality of liquid crystal boards in sequence so as to perform the machining process for a display panel continuously.

9. The processing process for a display panel according to claim 3, further comprising
arranging a plurality of liquid crystal boards in sequence so as to perform the machining process for a display panel continuously.

10. The processing process for a display panel according to claim 4, further comprising
arranging a plurality of liquid crystal boards in sequence so as to perform the machining process for a display panel continuously.

11. The processing process for a display panel according to claim 5, further comprising
arranging a plurality of liquid crystal boards in sequence so as to perform the machining process for a display panel continuously.

12. A processing device for a display panel, comprising:
a transmission apparatus for transmitting a liquid crystal board;
a clamping apparatus for clamping the liquid crystal board, wherein the clamping apparatus is arranged at an output port of the transmission apparatus;
a cutting apparatus installed correspondingly to the clamping apparatus and for perform single glass cutting on the liquid crystal board;
a removal apparatus installed at a downstream of the clamping apparatus and butted with the clamping apparatus, wherein the removal apparatus takes out residual material from split pieces formed by cutting the liquid crystal board after cutting; and
an output apparatus arranged at a downstream of the removal apparatus and butted with the removal apparatus.

13. The processing device for a display panel according to claim 12, further comprising
a checking apparatus for checking a cutting quality of the liquid crystal board, wherein the checking apparatus is installed correspondingly to the removal apparatus and is arranged oppositely to a cutting region of the liquid crystal board.

14. The processing device for a display panel according to claim 12, wherein the clamping apparatus comprises two sets of clamps; and the two sets of clamps are arranged oppositely to each other and configured to symmetrically clamp two opposite side edges of the liquid crystal board.

15. The processing device for a display panel according to claim 14, wherein each set of the clamps is provided with an elastic clamping layer for contacting the liquid crystal board.

16. A processing process for a display panel, comprising:
spreading and brushing an insulating spacer layer on an array pad;
arranging a glass panel on the spacer layer, wherein a cutting region of the glass panel is in contact with the spacer layer and the spacer layer prevents static electricity between the glass panel and the array pad;
performing single glass cutting on the cutting region of the glass panel;
taking out residual material from split pieces on the glass panel after cutting; and
removing the spacer layer, exposing the array pad, and then outputting a liquid crystal board.

17. The processing process for a display panel according to claim 16, wherein the spacer layer is made of polyimide or polymethyl methacrylate.

18. The processing process for a display panel according to claim 16, wherein after the spacer layer is removed and the array pad is exposed, before the liquid crystal board is outputted, a split region of the liquid crystal board is checked by a line scan camera to determine whether the split region meets a cutting requirement to output the liquid crystal board.

19. The processing process for a display panel according to claim 16, wherein the glass panel and the array pad are fixedly clamped by a clamping apparatus when performing single glass cutting on the cutting region of the glass panel, and two opposite side edges of the glass panel and the array pad are symmetrically clamped by the clamping apparatus.

20. The processing process for a display panel according to claim 16, further comprising
arranging a plurality of liquid crystal boards in sequence so as to perform the machining process for a display panel continuously.
